(19) United States
(12) Patent Application Publication
(10) Pub. No.: US 2011/0207095 A1
(43) Pub. Date: Aug. 25, 2011

(54) Teaching Language Through Interactive Translation

(75) Inventors: Shrikanth Narayanan, Santa Monica, CA (US); Panayiotis Georgiou, La Crescenta, CA (US)

(73) Assignee: UNIVERSITY OF SOUTHERN CALIFORNIA, Los Angeles, CA (US)

(21) Appl. No.: 13/048,754

(22) Filed: Mar. 15, 2011

Related U.S. Application Data
(62) Division of application No. 11/749,677, filed on May 16, 2007.
(60) Provisional application No. 60/801,015, filed on May 16, 2006.

(51) Int. Cl. G09B 19/06

(52) U.S. Cl. 434/157

(57) ABSTRACT

An application (computer program, an embodiment can be a game) which requires translation as one of its metrics is used to help the user can learn a language while operating the system (in a game embodiment, playing the game). The interaction is carried out only in a foreign language, but the application also includes translation capability. A virtual buddy can be used to translate between the native language and the foreign language so that the user can translate information and eventually learn information about the language by the process of interacting with the system (in an embodiment playing the game).

### CROSS-REFERENCE TO RELATED APPLICATIONS

This application is a divisional application of and claims the benefit of priority to U.S. application Ser. No. 11/749,677, filed May 16, 2007, which is non-provisional of U.S. Provisional Application 60/801,015, filed May 16, 2006. The disclosures of the prior applications are considered part of and are incorporated by reference in the disclosure of this application.

### FEDERALLY SPONSORED RESEARCH OR DEVELOPMENT

The U.S. Government may have certain rights in this invention pursuant to Grant No. N66001-02-C-6023 awarded by DARPA/SPAWAR.

### BACKGROUND

Spoken translation systems receive spoken words and/or phrases in a first language called a source language, and convert that language into a second language called a target language. The translation can be based on training corpora e.g., trained based on statistical techniques, or prior human knowledge e.g. manual translations or semantics.

### SUMMARY

The present application describes language teaching using a bi- or multi-lingual interactive setting. An embodiment describes teaching language via a game interface.

### BRIEF DESCRIPTION OF THE DRAWINGS

These and other aspects will now be described in detail with reference to the accompanying drawings, wherein:

FIG. 1 illustrates an embodiment where a computer runs a program that is stored on the storage media; and

FIG. 2 shows a flowchart which illustrates the computer operation.

### DETAILED DESCRIPTION

The general structure and techniques, and more specific embodiments which can be used to effect different ways of carrying out the more general goals, are described herein.

An embodiment describes teaching language and literacy in an interactive setting, through the use of programs, and programmed computers. In an embodiment, the translation system is a spoken translation system used in an interactive environment.

A game may be used in an embodiment; e.g. a program that defines a final objective to be reached by one or more players. The game allows certain interactions to take place in a specified language. An embodiment uses a program that accepts expressions from the user in one language, called herein the source language, which may be, for example, the user's native language. Other operations can only be carried out in a “foreign” language called herein the target language, that is, the language being taught. These operations are used by the interactive system to learn about expressions in the target language. In the embodiment, the interaction is via spoken language; however, it can alternatively use written interaction.

An embodiment is based on the recognition that a language student, referred to as a “user”, is interacting with a character or characters in a game. That student may learn the language to be taught, herein the “foreign language” as a means of communication with characters in the game. In an embodiment, it is strongly encouraged to communicate with the characters via the foreign language. First language communication is strongly penalized, or may be prohibited according to a level of the user who is playing. The learning is done in a very natural way: by trying to communicate with a character.

An agent, such as a machine agent, can aid the user by translating the native language to the foreign language, to allow communicating the utterances to the character. The agent can also translate from the foreign language to the native language.

An embodiment can use a real-time human agent as an additional player. The agent can assist the user to translate spoken utterances.

An embodiment operates by the user querying the character. An example query might be the user asking the character “which door should I take to get out of this maze?”. However, in the game, the character does not speak the native language, and the user does not have sufficient knowledge of the foreign language. So instead, the user asks the agent; in an embodiment, the virtual buddy.

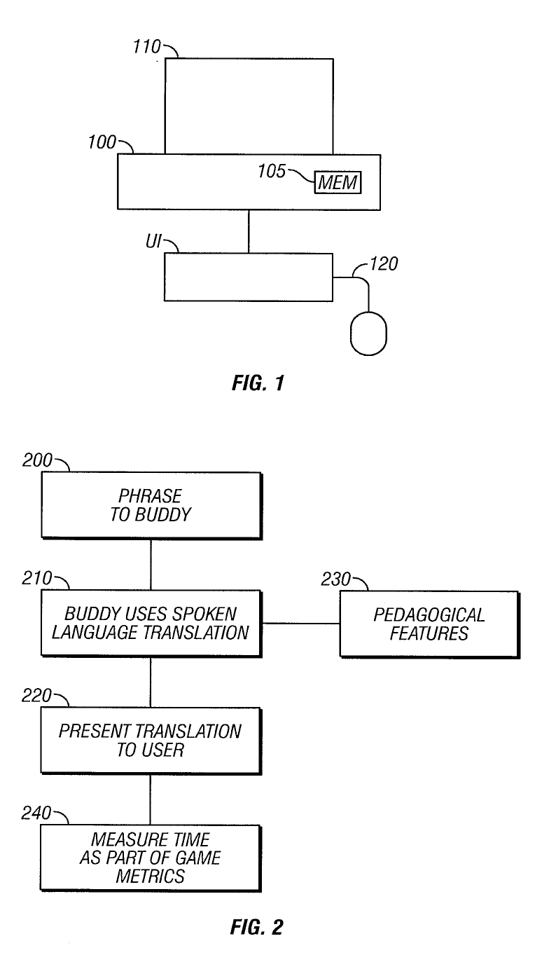

The operation can be carried out by a programmed computer that runs the flowcharts described herein. The computer can be as shown in FIG. 1. FIG. 1 illustrates an embodiment where a computer 100 runs a program that is stored on the storage media 105. The program produces output on a display 110. The user can interact with the program and display via a user interface which may include a keyboard, microphone, mouse, and any other user interface parts.

The computer operates according to the flowchart of FIG. 2. The user wants to interact with a character in the game, e.g., ask the character a question. The question, however, needs to be asked in the foreign language. At 200, the user passes a phrase to the “buddy”, the virtual translator. For example, the computer may ask a question such as “how do I say: which door do I take to get out of the maze?”.

The virtual buddy uses spoken language translation systems at 210 to provide spoken and written translation of the response in the foreign language. The translation is presented to the user at 220. The user can interact with the character by repeating the translated information to the character.

The character uses speech recognition technologies, and only responds if the user correctly spoke (pronunciation, syntax, context) the utterance. In order for the user to interact with the character in the game in progress, the user must learn or interact with the spoken language.

According to another embodiment illustrated by 230, pedagogical features can be included in the system. For example, the user can employ other techniques to communicate with the character at the cost of incurring a penalty. In one embodiment, the user can request their interpreter to act as a virtual translator. This incurs a penalty in the game, but allows the user to play an easier version of the game and score lower. In other words, the users are rewarded with more points when they speak the utterances themselves, but they can play a version of the game where the agent does the speaking.

Moreover, the time taken to complete the task can be one of the game metrics as shown as 240. This rewards the user who attains knowledge and retains it, who thus obtains faster times and hence better scores as compared with the user who requires continuous assistance from the interpreter.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative that might be predictable to a person having ordinary skill in the art. For example, other interactive environments, other than a game, can be used. Different kinds of games, including trivia games, role-playing games, virtual reality games, and others, are intended to be encompassed.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, game console, or laptop.

The programs may be written in C, or C++, or Python, or Java, or Brew, or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A computer-implemented method of assisting a conversation involving two languages, the method comprising:
receiving from a user, at a machine translation system comprising a user interface and a processor, a speech input spoken in a first language requesting to interact with a machine agent, wherein the speech input comprises a request to the machine agent to provide at least a speech output in a second language that is equivalent to a phrase spoken by the user in the first language;
responsive to the received speech input, providing the requested speech output in the second language that is equivalent to the phrase spoken by the user in the first language;
receiving from the user a reply speech input mimicking the speech output in the second language;
judging a correctness of pronunciation of the reply speech input in the second language; and
responding to the reply speech in the second language only when the pronunciation of the reply speech is judged to be correct in the second language.

2. The computer-implemented method of claim 16, wherein the conversation is a part of a game.

3. The computer-implemented method of claim 17, wherein the reply speech input is directed at a game character different from the machine agent.

4. The computer-implemented method of claim 16, further comprising responsive to the received speech input, providing a text output that is equivalent to the phrase spoken by the user in the first language.

5. A computer-implemented method of assisting a conversation involving two languages, the method comprising:
receiving from a user, at a machine translation system comprising a user interface and a processor, a speech input spoken in a first language requesting to interact with a machine agent, wherein the speech input comprises a request to the machine agent to communicate to a virtual character on behalf of the user in a second language that is equivalent to a phrase spoken by the user in the first language; and
responsive to the received speech input, communicating to the virtual character in the second language that is equivalent to the phrase spoken by the user in the first language

6. The computer-implemented method of claim 20, wherein the conversation is a part of a game.

7. The computer-implemented method of claim 21, wherein the virtual character is different from the machine agent.

8. The computer-implemented method of claim 20, further comprising responsive to the received speech input, providing a text output that is equivalent to the phrase spoken by the user in the first language.

9. A computer-implemented method of assisting a conversation involving two languages, the method comprising:
providing, at a machine translation system comprising a user interface and a processor, a machine agent in a game configured to assist a user to converse with a game character in a second language different from a first language spoken by the user, wherein the machine agent is configured to provide one of the following responsive to a speech input from a user:
provide a speech output in the second language that is equivalent to a phrase spoken by the user in the first language, wherein the user can mimic the speech output in the second language to converse with the game character, and
communicate directly to the game character in the second language on behalf of the user speaking in the first language;
receiving from a user, the speech input spoken in the first language requesting to interact with the machine agent; and
responsive to the received speech input, providing the requested speech output in the second language that is equivalent to the phrase spoken by the user in the first language or communicate directly to the game character in the second language on behalf of the user speaking in the first language.

10. The computer-implemented method of claim 24, further comprising:
when providing the requested speech output in the second language that is equivalent to the phrase spoken by the user in the first language,
waiting to receive from the user a reply speech input mimicking the speech output in the second language;
judging a correctness of pronunciation of the reply speech input in the second language; and
responding to the reply speech in the second language only when the pronunciation of the reply speech is judged to be correct in the second language.

11. The computer-implemented method of claim 25, further comprising responsive to the received speech input, providing a text output that is equivalent to the phrase spoken by the user in the first language.

12. The computer-implemented method of claim 24, wherein the virtual character is different from the machine agent.

13. A machine translation system for assisting a conversation involving two languages, the system comprising:
a user interface, including at least a microphone to receive a speech input from a user spoken in a first language; and
a processor executing instructions to perform speech recognition on the received speech input to provide a speech output in a second language,
wherein
the speech input comprises a request to a machine agent to provide at least a speech output in a second language that is equivalent to a phrase spoken by the user in the first language,
responsive to the received speech input, the processor is configured to instruct the machine agent to provide the requested speech output in the second language that is equivalent to the phrase spoken by the user in the first language,
the user interface is configured to recive from the user a reply speech input mimicking the speech output in the second language, and
the processor is configured to judge the correctness of pronunciation of the reply speech input in the second language, and instruct the machine agent to respond to the reply speech in the second language only when the pronunciation of the reply speech is judged to be correct in the second language.

14. The machine translation system of claim 28, wherein the system is configured to assist the conversation as a part of a game.

15. The machine translation system of claim 29, wherein the reply speech input is directed at a game character different from the machine agent.

16. The machine translation system of claim 28, wherein the processor is further configured to provide a text output that is equivalent to the phrase spoken by the user in the first language responsive to the received speech input.
